(19) United States
(12) Patent Application Publication
(10) Pub. No.: US 2012/0122328 A1
(43) Pub. Date: May 17, 2012

(54) Grounding Contact

(76) Inventors: Reinhard Buhri, Frastanz (AT); Stefan Bonig, Achberg-Esseratsweiler (DE)

(21) Appl. No.: 13/289,682

(22) Filed: Nov. 4, 2011

(30) Foreign Application Priority Data
Nov. 5, 2010 (DE) 102010043509.0

(51) Int. Cl. H01R 13/648; B23P 17/00; H05F 3/02; B23P 11/00; H01R 43/00

(52) U.S. Cl. 439/108; 29/525.01; 29/446; 29/825; 29/426.2; 29/525.14

(57) ABSTRACT

A grounding contact for grounding a structure made of metal is provided. The grounding contact comprises a grounding attachment part having a grounding contact surface for placement on the structure. A pin attaches the grounding attachment part to the structure. The grounding contact includes a contact surface for contacting a ground wire. The grounding attachment part also includes a blind hole that accepts the pin to help ensure that corrosion is permanently avoided between the bearing contact surface of the grounding attachment part and the structure.

### RELATED APPLICATIONS

The present application claims priority to German Patent Application DE 10 2010 043 509.0, filed Nov. 5, 2010, and entitled “Erdungskontakt” (“Grounding Contact”), the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a grounding contact for grounding a structure made of metal, a method for attaching a grounding contact on a structure, and a structure including a grounding contact.

For structures made of metal, especially steel, it is similar to that with machines meaning the structure needs to be grounded, in order that the structure, when subjected to electrical current or lightning strikes, protects people or property from the lethal health hazard or deadly current. For this purpose, the structures are provided with a grounding point at which one grounding contact is attached. The grounding contact is connected to a ground wire, which is grounded, so that due to the electrically conductive connection between the ground wire, the grounding contact and the structure, the structure is grounded.

For structures made of steel, which are generally provided with an organic protective coating, the protective coating must be removed extensively first before a steel plate is soldered on. Subsequently, a large stud is soldered onto this steel plate in a complicated way. A grounding contact can be attached to the threaded bolt. Thus, the electrical connection to the grounding is assured, because a ground wire is attached to the grounding contact and is mechanically and electrically contacted. Subsequently, these parts are provided with a corrosion protection, for example a protective coating. This is a costly and labor-intensive and thus expensive approach to grounding a structure.

From U.S. Pat. No. 6,991,478 B2 a grounding contact for the grounding of an aircraft is known. The grounding contact has a grounding attachment part. The grounding attachment part is provided with a through hole and a seal. Due to the through hole on the grounding attachment part liquid can enter the contact surface between the grounding attachment part and the aircraft, so that there is the risk of corrosion between the grounding attachment part and the grounding contact surface on the aircraft.

### BRIEF SUMMARY OF THE INVENTION

An object of embodiments of the present invention is to provide a grounding contact, a method for attaching a grounding contact to a structure, and a structure including a grounding contact, where corrosion between the grounding contact surface of a grounding attachment part and the structure can be permanently avoided.

This problem may be addressed with a grounding contact for grounding a structure comprising a grounding attachment part with a grounding contact surface for resting on the structure, a receptacle for a fastening element, such as a cartridge-fired pin, for fixing the grounding attachment part to the structure, and a contact surface for contacting a ground wire, whereby the grounding attachment part has a blind hole and the cartridge-fired pins may be fastened in the blind hole of the grounding attachment part. After fixing, the cartridge-fired pin is preferably set in the blind hole of the grounding attachment part. No fluid, such as a liquid or a gas with water vapor, can enter through the grounding attachment part to the grounding contact surface and/or into the blind hole. In this manner, a permanent corrosion protection between the grounding contact surface and the structure or component of the structure is ensured.

In particular embodiments, the grounding attachment part may be formed as a single piece.

In another embodiment, the grounding attachment part is provided with a seal on the grounding contact surface, for example a seal ring. The seal ensures a particularly good seal between the grounding contact surface and the structure or component of the structure. The seal preferably completely surrounds the ground contact surface or a portion of the ground contact surface so that thereby no moisture or liquid can penetrate on the surface area between the grounding contact surface of the grounding attachment part and the surface of the structure or component of the structure, on which the grounding contact surface rests due to the seal's seal. Thus, this keeps the area between the grounding contact surface and the structure protected from moisture or liquid, especially water, and permanent corrosion protection of the contact area between the grounding contact surface and the structure or component of the structure is ensured.

In an additional embodiment the seal is fixed to a groove, in particular, an annular groove disposed on the grounding contact surface.

Preferably, the cartridge-fired pin has an interlocking and/or friction-locked and/or firmly bonded compound fixed in the blind part of the grounding attachment part. The cartridge-fired pin can be fixed in the blind hole or the grounding attachment part, for example, with a bayonet mount, a locking connection, or a firmly bonded connection such as a soldered connection.

In one variant, the cartridge-fired pin is provided with a male thread and the grounding attachment part is provided with a female thread in the blind hole and, by means of the male and female thread, the cartridge-fired pin is connected to the grounding attachment part. With a threaded connection between the cartridge-fired pin and the grounding attachment part, following the fixing of the cartridge-fired pin to the structure or the component, simply by bolting down the grounding attachment part using a compressive force applied to the structure or component, a large compressive force exists between the grounding contact surface of the grounding attachment part for a permanent contact and/or a fluid-tight seal between the grounding attachment part and the structure or component.

It is suitable that the grounding attachment is formed as a solid material without a cavity and/or that the blind hole displays the only fluid-conducting connection on the grounding attachment. The grounding attachment part has no additional fluid-conducting connection, such as a channel or opening of the blind hole in the area other than that of the blind hole opening, so that the grounding contact surface on the structure is thus completely sealed, because due to the grounding attachment part, no fluid, such as water, can enter the grounding contact surface and/or the blind hole.

In another embodiment the grounding attachment part consists at least partially, in particular, completely of metal, for example, steel, stainless steel, copper or aluminum.

Embodiments of the present invention relate to a process for attaching a grounding contact with a grounding attachment part and a grounding contact surface to a structure made of metal or a component of a structure, such as a wall or a ceiling or a beam of a structure made of metal, comprising the steps: Attaching a cartridge-fired pin to the structure or component, placing and contacting of the grounding attachment part to the grounding contact surface on the structure or component, fixing the pin to the grounding attachment part whereby the grounding contact surface is sealed by a seal, in particular a sealing ring, and/or the grounding contact is constructed as described in this property right application.

In particular embodiments, the grounding contact area is sealed from the seal so that no fluid can be introduced between the grounding contact surface and the structure or component at the grounding contact surface and/or the seal is arranged between the grounding attachment part and the structure or component.

In a further embodiment, the seal, when loading the grounding attachment part to the structure or component, is elastically tensioned. Due to the elastic tension of the seal between the grounding attachment part and the structure, a sufficient sealing can be ensured for deformations, in particular, temperature-induced deformations of the grounding attachment part and/or the pin and/or the structure, because even with such deformations or strains, with an elastically tensioned seal, a reliable seal between the grounding attachment part and the structure or component can still be ensured.

In a supplemental embodiment a ground wire is mechanically and electrically contacted with the grounding attachment part.

In another embodiment, coatings, in particular electrically poor- or non-conductive coatings, for example, as a protective coating or a hot galvanization of the structure or component, are removed before the placement of the grounding contact surface of the grounding attachment part onto those areas on which the grounding contact surface is placed on the structure of the components. Such coatings should be removed prior to the placement of the grounding contact surface onto the structure or component so that a sufficient current-carrying connection exists between the structure or the component and the grounding attachment part.

In a further embodiment, the pin is attached in a through hole or blind hole of the structure or component by means of soldering, screwing, or pressing.

A structure or component according to aspects of the present invention, for example, a wall or ceiling, or a beam, includes a grounding contact attached to the structure or components with a grounding attachment part with a grounding contact surface, whereby between the grounding attachment part and the structure or component a seal is fixed, so that the grounding contact surface and the surface of the structure or the component on which the grounding contact surface rests, is designed in a sealed manner relative to the surrounding area and/or the grounding contact is designed as a grounding contact as described above.

### BRIEF DESCRIPTION OF SEVERAL VIEWS OF THE DRAWINGS

An illustrative embodiment of the invention is more closely described below with reference to the following illustrations.

FIG. 1 provides a cross-section of a grounding contact attached to a structure in accordance with an embodiment of the present invention.

FIG. 2 provides a perspective view of the grounding contact of FIG. 1.

### DETAILED DESCRIPTION OF THE INVENTION

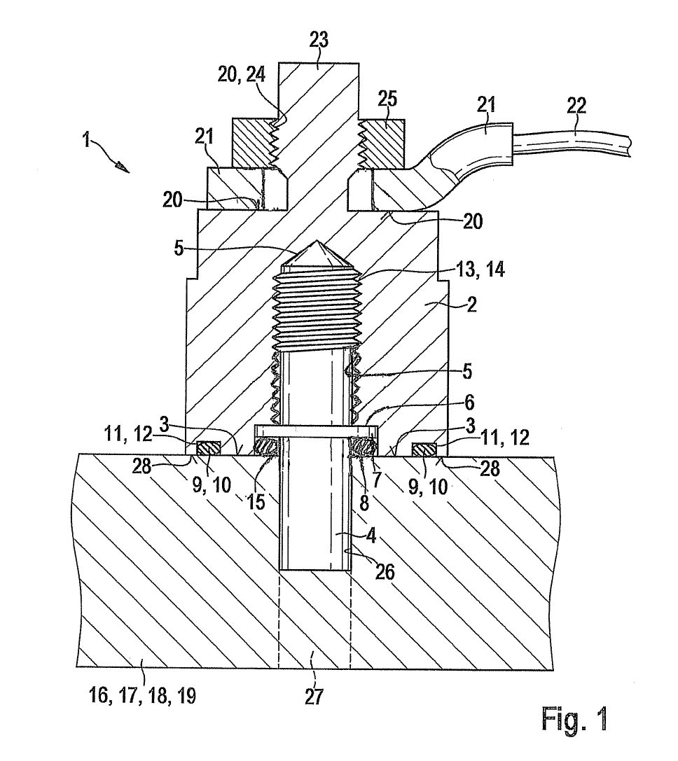

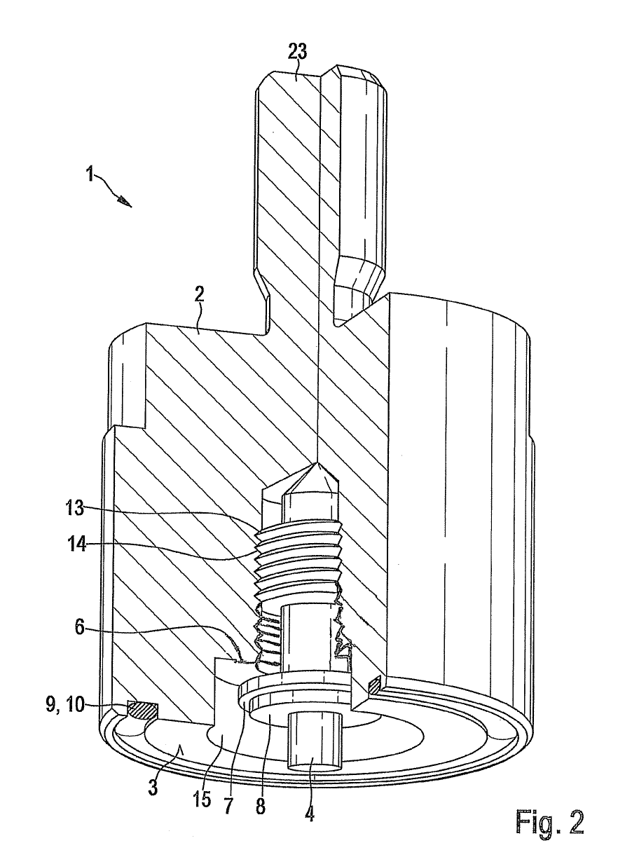

In FIGS. 1 and 2 a grounding contact 1, formed in accordance with an embodiment of the present invention, for the grounding of a structure 16 made of metal, in particular, steel is shown. The structure 16 for example, depicts a steel structure and requires the grounding contact 1 for grounding in order to avoid damage to persons and goods when there is electricity because the grounding can discharge the electricity.

The grounding contact 1 features a grounding attachment part 2. The grounding attachment 2 consists of solid steel or copper and has a blind hole 5 and a contact piece 23 with a male thread 24 on the outside as shown in FIG. 1. A lug 21, which is connected to a ground wire 22, is slid onto the contact piece 23. Here, the lug 21 is secured with a nut 25 with a female thread to the grounding attachment part 2. Thus, male thread 24 on the contact piece 23 or the remaining contact surfaces of the lug 21 on the grounding attachment part 2 is made available as a contact surface 20 for contacting the lug 21 with the grounding attachment part 2 for example.

The blind hole 5 has only one blind hole opening 15. From the blind hole 5 only the blind hole opening 15 leads into the grounding attachment part 2. The blind hole 5 has two different diameters, so that a level 6 appears on the blind hole 5. The upper end of the blind hole 5 is provided with a female thread 14. The grounding contact 1 is for grounding the structure 16 or a component 17 of the structure 16, for example a wall 18 or a beam 19. In FIG. 1 the structure 16 or the component 17 is shown only partially. The structure 16 or the component 17, for example, is made of steel or aluminum. Prior to the fixing of the grounding contact 1 a blind hole 26, for example, with drilling, must initially be incorporated in the structure 16. Subsequently, in the range of the blind hole 16 on one face 28 of the structure 16, on which the grounding attachment part 2 is subsequently placed, an existing protective coating is to be removed. Notwithstanding this, a through-hole 27 can be incorporated into the structure 16 which in FIG. 1 is represented by dashed lines. Subsequently, a cartridge-fired pin 4 is inserted into the blind hole 26 or in the through hole 27 and connected with the structure 16. For example, the cartridge-fired pin 4 may be soldered to the blind hole 26 of the structure 16.

The grounding attachment 2 has a grounding contact surface 3 to be placed on the structure 16 or component 17. Also, in the area of the grounding contact surface 3 the grounding attachment part 2 is provided with a groove 11 formed as a annular groove 12. In the annular groove 12, a sealing ring 10 is inserted as a seal 9. In the illustrated embodiment, the sealing ring 10 consists of an elastic material, such as rubber or plastic material. For attaching, the grounding attachment part 2 is attached to the cartridge-fired pin 4, which are already applied to the structure 16 with a support ring 7 and the sealing ring 8, in that the pin 4 is screwed into the blind hole 5 of the grounding attachment part 2. In this case, the cartridge-fired pin 4 in the area of its upper end features a male thread 13 as shown in FIG. 1. The grounding attachment part 2 can be connected to the cartridge-fired pin 4 with the help of male thread 13 on the cartridge-fired pin 4 and the female thread 14 on the blind hole 5 by a screwing action. In this manner, the grounding attachment 2 is screwed on to the cartridge-fired pin 4 until the grounding contact surface 3 of the grounding attachment part 2 rests on the surface 28 of the structure 16 or the component 17 which results in a pretension force between the grounding contact surface 3 and the surface 28 of the structure 16.

The seal 9 is introduced into the annular groove 12 so that before screwing on the grounding attachment 2 to the cartridge-fired pin 4 the sealing ring 10 is slightly protruding from the annular groove 12. Thus, by the tightening of the grounding attachment part 2 to the pin 4 and the pretension force associated between the grounding contact surface 3 and the surface 28 of the structure 16 or the component 17, the sealing ring 10 is elastically tensioned. The sealing ring 10, thereby completely surrounds the grounding contact surface 3 inside the sealing ring 10, thereby ensuring a complete seal between the grounding contact surface 3 and the surface 28 of the structure 16, on which the grounding contact surface 3 rests.

In the illustrated embodiment, the grounding attachment part 2 is made of solid material in one piece or is produced in one piece, so that in blind hole 5 there are no channels or openings leading to the blind hole 5. Thereby the area between the grounding contact surface 3 and the surface 28 of structure 16 is completely and permanently sealed, because no fluids, especially liquids such as water, can enter this region. If the cartridge-fired pin 4 is mounted to a through hole 27 instead of the blind hole 26, it is necessary, in order to maintain a seal, to seal through hole 27 completely, for example by arranging an additional seal in the cartridge-fired pin 4 and the structure 16 or component 17 of the structure 16 at the other end of the through hole 27 on which a grounding attachment part 2 is not fixed (not shown).

There are significant advantages in connection with an inventive grounding contact formed in accordance with aspects of the present invention, such as grounding contact 1. After securing the grounding contact 1 to the structure 16, the area between the grounding contact surface 3 and the surface 28 of the structure 16, on which the grounding contact surface 3 rests, is completely and permanently sealed, because on one hand the completely encircling resilient seal ring 10 is arranged between the grounding attachment part 2 and the structure 16 and, on the other hand, there are no openings or channels present on the grounding attachment part 2 which lead from the area of the grounding contact 1 into the blind hole 5.

1. A grounding contact for grounding a structure made of metal, the grounding contact comprising
a grounding attachment part including a grounding contact surface for placement on the structure;
a receptacle for a fastening element for fixing the grounding attachment part) to the structure; and
a contact surface for contacting a ground wire;
wherein the receptacle surrounds a blind hole and the fastening element is attached in the blind hole.

2. A grounding contact according to claim 1, wherein the grounding attachment part is formed as a single piece.

3. A grounding contact according to claim 1, wherein the grounding contact surface accepts a seal.

4. A grounding contact according to claim 3, wherein the grounding contact surface includes a groove for accepting the seal.

5. A grounding contact according to claim 4, wherein the groove comprises an annular groove, and the seal comprises a seal ring, wherein the annular groove accepts the seal ring.

6. A grounding contact according to claim 1, wherein the fastening element can be fixed in the blind hole by one of pressing, threading, or bonding.

7. A grounding contact according to claim 1, wherein the blind hole includes a female thread for accepting a male thread of the fastening element to connect the fastening element to the grounding attachment part.

8. A grounding contact according to claim 1, wherein the grounding attachment part includes a blind hole opening for the blind hole, the blind hole opening being the only fluid-conducting connection in the grounding attachment part.

9. A grounding contact according to claim 1, wherein the grounding attachment part consists at least partially of a metal.

10. A method for attaching a grounding contact with a grounding attachment part including a grounding contact surface to a structure made of metal or a component of a structure, made of metal, the method comprising:
attaching a fastening element to the structure or component;
placing the grounding surface of the grounding attachment part to the structure or the component; and
attaching the fastening element to the grounding attachment part;
wherein the grounding contact surface is sealed.

11. A method according to claim 10, wherein the grounding contact surface is sealed by a seal arranged between the grounding attachment part and the structure or the component.

12. A method according to claim 10, wherein the seal is elastically tensioned when the grounding attachment part is placed in contact with the structure or the component.

13. A method according to claim 10, further comprising placing a ground wire mechanically and electrically in contact with the grounding attachment part.

14. A method according to claim 10, further comprising removing one or more coatings of the structure or the component before contacting the grounding contact surface of the grounding attachment part to the structure or the component in those areas on which the grounding contact surface contacts the structure or component.

15. A method according to claim 10, further comprising securing the fastening element in a through hole or a blind hole of the structure or component with one of soldering, screwing, or pressing.

16. A system including
a structure or component of a structure;
a grounding contact, the grounding contact including a grounding attachment part with a grounding contact surface, the grounding contact securable to the structure or component with the grounding attachment part; and
a seal;
wherein the seal is arranged between the grounding attachment part and the structure or component to which the grounding attachment part is securable, whereby the grounding contact surface and a surface on the structure or component on which the grounding contact surface rests are sealed in a fluid-proof manner in the area of the seal.
